(19) United States
(12) Patent Application Publication
(10) Pub. No.: US 2025/0029471 A1
(43) Pub. Date: Jan. 23, 2025

(54) FORGOT MY PHONE SYSTEM

(71) Applicant: SYLIA GALLEGOS, DALLAS, TX (US)

(72) Inventor: SYLIA GALLEGOS, DALLAS, TX (US)

(21) Appl. No.: 18/780,322

(22) Filed: Jul. 22, 2024

Related U.S. Application Data
(60) Provisional application No. 63/514,795, filed on Jul. 20, 2023.

(51) Int. Cl. G08B 21/18; H04W 4/029

(52) U.S. Cl. CPC G08B 21/182; H04W 4/029

(57) ABSTRACT

A proximity alert device includes circuitry within an outer housing that is in communication with one or more interfaces for the tracking, monitoring, and locating of a paired remote electronic device. The interface is in communication with the circuitry and is configured to send data through the circuitry to perform a task. The remote electronic device is in wireless communication with the circuitry. The circuitry monitors the location of the remote electronic device. When the circuitry is configured to automatically emit a notification when the location of the remote electronic device exceeds a preselected distance from the circuitry. A microphone is within the housing and in communication with the interface and configured to capture sound which may be transmitted to the remote electronic device.

### CROSS REFERENCE TO RELATED APPLICATIONS

This application claims the benefit of an earlier filing date and right of priority to U.S. Provisional Application No. 63/514,795, filed 20 Jul. 2023, the contents of which is incorporated by reference herein in its entirety.

### BACKGROUND OF THE INVENTION

### 1. Field of the Invention

The present application relates to an electronic proximity alert device, and more particularly to an electronic device configured to alert a user when separated from an object such as a cell phone.

### 2. Description of Related Art

The telephone had humble beginnings as early as 1876 when Alexander Graham Bell received the first patent for a device that clearly reproduced the human voice on a second remote device. At first, telephones were directly connected by wires to offices or residences. The direct connection proved impractical as the device became more popular and manually operated switchboards were introduced. As progress continued the switchboards or exchanges were soon connected together to form an automated worldwide system. The analog systems for telephones developed, and the technology provided business and public uses with an acceptable but limited service. In the late 1940s, the invention of the transistor dramatically changed the telephone industry. The introduction of the transistor and the conversion to digital communications revolutionized the industry. The new technologies-initiated innovations such as the cordless phone and soon, mobile phones.

The ease, portability, and access to apps that create other functions on a mobile phone led to the description of “Smartphone” as any phone based on the innovative technology introduced by Apple. One of the issues with the smartphone is now individuals' dependence on the phone. Many people consider the phone a necessary device, and they have difficulty functioning without it. Forgetting and leaving their phone someplace is regarded as an emergency, creating a sense of panic when the situation is realized.

Forgetting is all too typical in everyday life. The average person misplaces up to nine items every day, and one-third of those surveyed claimed they spend an average of 15 minutes per day looking for items—cellphones, keys, and papers being at the top of the list. Daily forgetfulness is irritating, and it frequently leads to individuals being late, which is inconvenient for both themselves and others. Little memory lapses are common in people of all ages and can happen to everyone. Our genes play a role, but stress, exhaustion, and multitasking can worsen our proclivity to make such mistakes. In a world where we are always traveling and leaving from one location to another, it is easy to leave behind a range of items, including our phones. Forgetting is so commonplace that you most likely rely on a variety of strategies to help you remember crucial information, such as taking notes in a daily planner or booking key appointments on your phone's calendar. Technology has advanced far enough to present a viable solution to this issue.

Although strides have been made, shortcomings remain. It is desired that an assembly be provided that can stay with a user to prevent them from forgetting their phones.

### BRIEF SUMMARY OF THE INVENTION

It is an object of the present application to provide a unique and clever use of innovation to notify a person that they have been separated from their phone. The system is a compact electronic device utilizing circuitry including a processor, storage device, and interface to send and receive data and communicate wirelessly with other electronic devices. The system is compact and meant to be lightweight and sturdy enough to handle daily life. It is an object that the system be linkable with a cellular phone and be configured to monitor the distance between itself and the cellular phone. If a person carrying the system reaches a certain distance from the phone, the system will emit an audio warning reminding the person that they are leaving their phone behind or have already forgotten their phone. Depending on the user's preferences, the warning might be a voice or any other audible sound. The device interfaces with the phone and is configurable for user preferences via an app. A GPS location service is also offered.

It is a further object of the present application that the system is the ability to communicate with the phone in both directions. For example, a person could forget their phone in a taxi, rideshare, or another person's vehicle. In such circumstances, users may utilize the built-in interface to transmit a preset or standard message to the driver or person in possession of the phone as a means of easily grabbing their attention in an easy and quick manner.

Ultimately the invention may take many embodiments. In these ways, the present invention overcomes the disadvantages inherent in the prior art. The more important features have thus been outlined in order that the more detailed description that follows may be better understood and to ensure that the present contribution to the art is appreciated. Additional features will be described hereinafter and will form the subject matter of the claims that follow.

Many objects of the present application will appear from the following description and appended claims, reference being made to the accompanying drawings forming a part of this specification wherein like reference characters designate corresponding parts in the several views.

Before explaining at least one embodiment of the present invention in detail, it is to be understood that the embodiments are not limited in its application to the details of construction and the arrangements of the components set forth in the following description or illustrated in the drawings. The embodiments are capable of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the various purposes of the present design. It is important, therefore, that the claims be regarded as including such equivalent constructions insofar as they do not depart from the spirit and scope of the present application.

### BRIEF DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 is a front view of an electronic reminding device according to an embodiment of the present application.

FIG. 2 is an alternate front view of the device of FIG. 1 in association with a set of keys.

FIG. 3 is an offset rear exploded view of the device of FIG. 1.

While the embodiments and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION OF THE INVENTION

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the embodiments described herein may be oriented in any desired direction.

The embodiments and method will be understood, both as to its structure and operation, from the accompanying drawings, taken in conjunction with the accompanying description. Several embodiments of the assembly may be presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless otherwise described.

Referring now to the Figures wherein like reference characters identify corresponding or similar elements in form and function throughout the several views. The following Figures describe embodiments of the present application and its associated features. With reference now to the Figures, embodiments of the present application are herein described. It should be noted that the articles “a”, “an”, and “the”, as used in this specification, include plural referents unless the content clearly dictates otherwise.

The Forgot My Phone system/device is a unique and clever use of innovation to notify a person that they have been separated from their phone. The system is a compact circular item meant to be lightweight and sturdy enough to handle daily life. If a person carrying the system reaches a certain distance from the phone, the system will emit an audio warning reminding the person that they are leaving their phone behind or have already forgotten their phone. Depending on the user's preferences, the warning might be a voice or any other audible sound. The device interfaces with the phone and is configurable for user preferences via an app. A GPS location service is also offered.

Another useful feature of the system is the ability to communicate with the phone in both directions. For example, a person could forget their phone in a taxi, rideshare, or another person's vehicle. In such circumstances, users may utilize the built-in microphone and speaker to transmit a preset or standard message to the driver or person in possession of the phone as a means of easily grabbing their attention in an easy and quick manner.

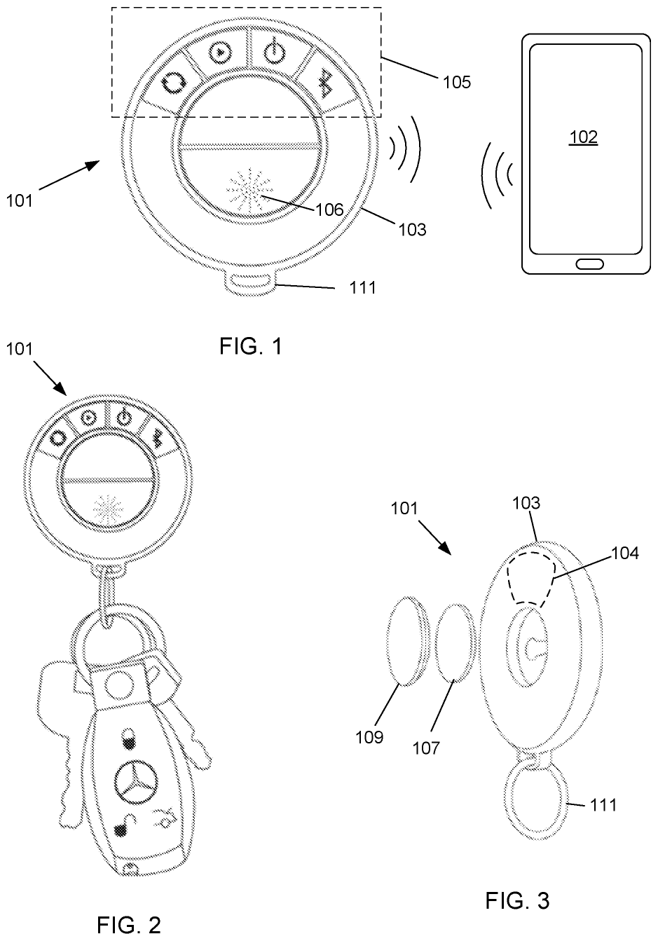

Referring now to FIGS. 1-3 in the drawings, assorted views of the Forgot My Phone system 101 is illustrated. System 101 is a small portable electronic device configured to be held or carried by a user. System 101 is in communication with a remote electronic device via one or more electronic communication methods. System 101 is configured to monitor the location of the user/housing as well as the location of the remote electronic device 102. System 101 is configured to audibly release a sound when a distance between system 101 and the remote electronic device exceeds a preset limit. In this manner system 101 acts as a reminder or loss prevention for the remote electronic device 102.

System 101 is configured to be in any shape or form. As illustrated in the figures system 101 is ideally suited to be carried as a key chain as shown in FIG. 2. The use of system 101 in communication with a key chain is merely exemplary in nature. Of most importance is the compact portable nature of system 101 so as to be easily carried by a user. This may be done in many different methods and forms.

System 101 includes a housing 103 and one or more user interfaces 105. Carried within housing 103 is circuitry 104 which may include one or more electronic devices such as a processor, a database (storage device), an input output interface, and memory. Circuitry 104 is configured to operate and respond to signals received from interfaces 105 as executed by a user. System 101 is configured to be operable with computer software applications that link it to a remote electronic device through wireless communications. This allows system 101 to be in communication with and monitor the location of the paired remote electronic device 102. Data may be transmitted between system 101 and the remote electronic device 102.

User interface 105 includes external buttons, sensors, switches, or other actionable devices that are situated around a portion of housing 103. A user is able to engage interface 105 to affect operational functions of system 101. For example, an interface may include an on or off button. Additionally, an interface may include the activation or deactivation of Bluetooth connectivity. This may be useful in pairing system 101 to a particular remote electronic device. Additionally other interfaces may include the ability to play or select audible sounds, adjust preset distance, or even capture audible communication from the user for transmission to the remote electronic device. Audible communication from a user may be captured through a speaker/microphone assembly 106. It is understood that the duration and type of messages or audible sounds generated are completely programmable by the user through interface 105. In one embodiment, sound may be emitted through assembly 106 to notify the user about his/her proximity to device 102, perhaps even to automatically adjust the speed of a sound to denote proximity closeness to the device 102.

In particular to FIG. 3 in the drawings, a rear offset exploded view of system 101 is provided. Housing 103 is constructed of durable materials and can be water resistant. A slim and unobtrusive design allows system 101 to be easily transported and concealed. Electronic components held within housing 103 may be accessed as seen in FIG. 3. A cap 109 may be removed from a back surface of housing 103 to expose a battery 107. It is understood that battery 107 provides electrical power configured to run the electrical components therein. Battery 107 may be a single use battery or configured for recharging. In a recharging configuration housing 103 may also incorporate a charging port in communication with battery 107. An example of battery 107 may be similar to that found with a watch.

In embodiments where system 101 is to be used with keys as shown in FIG. 2, a molded-in loop 111 may be included on an exterior surface of housing 103. Loop 111 may be used for the attachment of key rings.

In operation, system 101 is paired with a remote electronic device such as a cell phone. The pairing may be done via Bluetooth or other communication methods. When paired system one-on-one continually tracks or monitors the location of the remote electronic device and automatically determines the distance between itself and the remote electronic device. The distance is compared to preset allowable values for distance. Upon exceeding preset values for distance, system 101 will generate an audible sound reminding the user to go back to the remote electronic device. The audible sound may be generated through speaker 106.

Another practical use for system 101 is the ability for two-way communication with the remote electronic device. For example, a person may forget their phone in a transportation service such as a taxi, uber or other service. In such case, the user may use the built in microphone/speaker 106 to send a pre-recorded or standard message to the driver or whomever is in possession of the phone. Statements such as “You have my phone. Please return it” or “Please stop so I can retrieve my phone” may be made by the user in an effort to communicate with the individual near the remote electronic device. It is understood that such communications may be in real time conveying unique messages from the user directly to the location of the telephone. In other embodiments interface 105 may be engaged to tell the telephone to emit a standard pre-recorded message.

It is understood that system 101 in conjunction with the software application may permit a user to adjust the timing and types of messaging or audible signals provided. System 101 is fully programmable by the user via the application and can be tailored to each individual's preferences use cases and needs.

The particular embodiments disclosed above are illustrative only, as the application may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

What is claimed is:

1. A proximity alert device, comprising:
a housing;
a circuitry located within the housing;
an interface in communication with the circuitry, the interfaces configured to send data through the circuitry to perform a task; and
a remote electronic device in wireless communication with the circuitry, the circuitry configured to monitor the location of the remote electronic device;
wherein the circuitry is configured to automatically emit a notification when the location of the remote electronic device exceeds a preselected distance from the circuitry.

2. The device of claim 1, further comprising:
a microphone within the housing and in communication with the interface, the microphone configured to capture sound, wherein the circuitry is configured to transmit the sound to the remote electronic device.

3. The device of claim 2, wherein the remote electronic device is configured to automatically emit the sound.

4. The device of claim 1, wherein the interface is configured to pair the circuitry with the remote electronic device.

5. The device of claim 1, wherein the interface is configured to turn on and off the circuitry.

6. The device of claim 1, wherein the interface is configured to play or select audible sounds.

7. The device of claim 1, wherein the interface is configured to capture audible sounds.

8. The device of claim 1, wherein the interface is configured to play audible sounds.

9. The device of claim 1, wherein the circuitry includes a battery.

10. The device of claim 1, wherein the housing includes a circular loop.

11. The device of claim 1, wherein the location of the remote electronic device is transmitted to the circuitry.
